(19) United States
(12) Patent Application Publication
(10) Pub. No.: US 2014/0116809 A1
(43) Pub. Date: May 1, 2014

(54) CONTAINER TRANSPORTATION FORKLIFT

(71) Applicants: Zenghong Chen, Shenzhen (CN); Chunhao Wu, Shenzhen (CN); Kunhsien Lin, Shenzhen (CN); Minghu Qi, Shenzhen (CN); Zhenhua Guo, Shenzhen (CN); Weibing Yang, Shenzhen (CN)

(72) Inventors: Zenghong Chen, Shenzhen (CN); Chunhao Wu, Shenzhen (CN); Kunhsien Lin, Shenzhen (CN); Minghu Qi, Shenzhen (CN); Zhenhua Guo, Shenzhen (CN); Weibing Yang, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/703,349

(22) PCT Filed: Oct. 26, 2012
(86) PCT No.: PCT/CN2012/083552

§ 371 Date: Dec. 11, 2012

(30) Foreign Application Priority Data
Oct. 25, 2012 (CN) 201210412848.6

(51) Int. Cl. B66F 9/12

(52) U.S. Cl. CPC B66F 9/12
USPC 187/237

(57) ABSTRACT

A container transportation forklift includes a main body. The main body is configured with a roller guidance alignment device configured to guide a container to enter a limiting position of the container transportation forklift. The rollers in the roller guidance alignment device can rotate and have an automatic guidance function. The container transportation forklift does not need to be completely aligned with the container resulting in shorter regulation time, and increased transportation efficiency.

### TECHNICAL FIELD

The present disclosure relates to the field of transportation of special articles, and more particularly to a container transportation forklift

### BACKGROUND

Manufacturing technology of a liquid crystal display (LCD) panel is increasingly mature. Generation of a production line of the LCD panel and degree of automation are both becoming higher and higher. In some production lines, automatic material transportation systems are introduced. Workpieces manufactured on production line, such as LC glasses, are put in a container. The container is put into various storage cabinets. An automatic transportation vehicle of the automatic material transportation systems transports the container to various stations according to instructions.

Each of storage cabinets has a container inlet and outlet. Generally, people manually operate a forklift to put the container into the container inlet and outlet. To accurately put the container into a limiting position of the container transportation forklift, as shown in FIG. 1, a clamping, block 21 is put at a bottom of the container 2 in the prior art. A forklift 1 is configured with a latching groove 11. The clamping block 21 is aligned, with the latching groove 11 through manual visual operation, which limits a position of the container 2. Aligning the clamping block 21 with the latching groove 21 has an excellent effect, but takes more time and decreases transportation efficiency.

### SUMMARY

In view of the above-described problems, the aim of the present disclosure is to provide a container transportation forklift. The container transportation forklift can quickly enable a container to enter a limiting position of the container transportation forklift, with less time spending and high transportation efficiency.

The technical scheme of the present disclosure is that: A container transportation forklift comprises a main body configured with a roller guidance alignment device configured to guide a container to enter a limiting position of the container transportation forklift. The roller guidance alignment device comprises at least two oppositely positioned roller installation frames, two fixing shafts, four rollers, and a resetting piece. The fixing shafts are arranged on the main body of the container transportation forklift. The roller installation frames rotate around the fixing shafts and comprise a first arm and a second arm. The rollers are arranged on the first arm of the roller installation frames and the second arm of the roller installation frames. When the container is not on the container transportation forklift, the resetting piece enables the first arm and the second arm to incline upwards. When the container is on the container transportation forklift, the rollers on the first arm and the second arm contact with a sidewall and a bottom wall of the container. Axes of partial rollers are parallel to a length direction of the container transportation forklift. Axes of partial rollers are parallel to a width direction of the container transportation forklift. The resetting piece is a resetting spring. One end of the resetting spring is arranged on the second arm of the roller installation frames, and an opposite end of the resetting spring is arranged on the main body of the container transportation forklift.

Another technical scheme of the present disclosure is that: A container transportation forklift comprises a main body configured with a roller guidance alignment device configured to guide a container to enter a limiting position of the container transportation forklift.

In one example, the roller guidance alignment device comprises at least one roller installation frame and two rollers. The roller installation frame is arranged on the main body of the container transportation forklift. The two rollers are parallel, and a spacing is set between the two rollers. The spacing holds clamping blocks on the container. The rollers further clamp the clamping blocks of the container. In transportation process of the container transportation forklift, shake and vibration of the container can be alleviated, which avoids damaging workpieces in the container.

In one example, axes of the rollers are parallel to the width direction of the container transportation forklift. The the container transportation forklift does not need to be completely aligned with the container in the length direction of the container transportation forklift.

In one example, axes of the roller are parallel to the length direction of the container transportation forklift. The the container transportation forklift does not need to be completely aligned with the container in the width direction of the container transportation forklift.

In one example, the roller guidance alignment device comprises at least one roller installation frame and four rollers. The roller installation frame is arranged on the main body of the container transportation forklift. The axes of two rollers are parallel to the length direction of the container transportation forklift, and the axes of the other two rollers are parallel to the width direction of the container transportation forklift. The four rollers are arranged in a square. The container transportation forklift does not need to be completely aligned with the container in the length direction and the width direction of the container transportation forklift, obtaining better effect.

In one example, the roller guidance alignment device comprises at least two oppositely positioned roller installation frames, two fixing shafts, four rollers, and a resetting piece. The fixing shafts are arranged on the main body of the container transportation forklift. The roller installation frames can rotate around the fixing shafts and comprise a first arm and a second arm. The rollers are arranged on the first arm of the roller installation frames and the second arm of the roller installation frames. When the container is not on the container transportation forklift, the resetting piece enables the first arm and the second arm to incline upwards. When the container is on the container transportation forklift, the rollers on the first arm and the second arm contact with a sidewall and a bottom wall of the container.

In one example, the resetting piece is a resetting spring. One end of the resetting spring is arranged on the second arm of the roller installation frames, and an opposite end of the resetting spring is arranged on the main body of the container transportation forklift.

The present disclosure has the advantages that: The main body of the container transportation forklift of the present disclosure is configured with a roller guidance alignment device configured to guide the container to enter the limiting position of the container transportation forklift. The rollers in the roller guidance alignment device can rotate and have an automatic guidance function. The container transportation forklift is only roughly moved below the container to ensure that the container can be pressed at inner sides of the rollers. The container transportation forklift can be raised when the container transportation forklift does not need to be completely aligned with the container. In process of raising the container, the inner sides of the rollers are under stress so that the rollers rotate inwards. Thus, the container automatically enters the limiting position of the container transportation forklift. Because the container transportation forklift does not need to be completely aligned with the container, regulation time is shorter, and transportation efficiency is high.

### BRIEF DESCRIPTION OF FIGURES

FIG. 1 is a schematic diagram of a transportation state of a container transportation forklift in the prior art;

FIG. 2 is a schematic diagram of a transportation state in a first example of a container transportation forklift of the present disclosure;

FIG. 3 is a structural diagram of a roller guidance alignment device in a first example of a container transportation forklift of the present disclosure;

FIG. 4 is a schematic diagram of a transportation state in a second example of a container transportation forklift of the present disclosure;

FIG. 5 is a structural diagram of a roller guidance alignment device in a second example of a container transportation forklift of the present disclosure; and

FIG. 6 is a structural diagram of another angle of a roller guidance alignment device in a second example of a container transportation forklift of the present disclosure.

### DETAILED DESCRIPTION

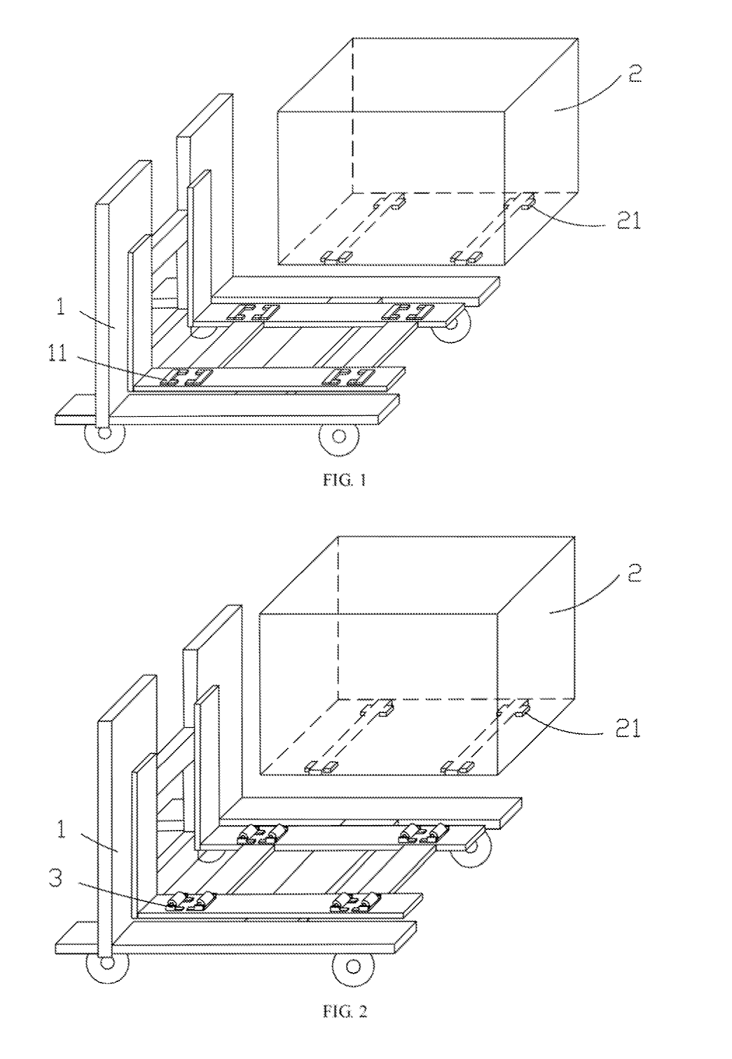

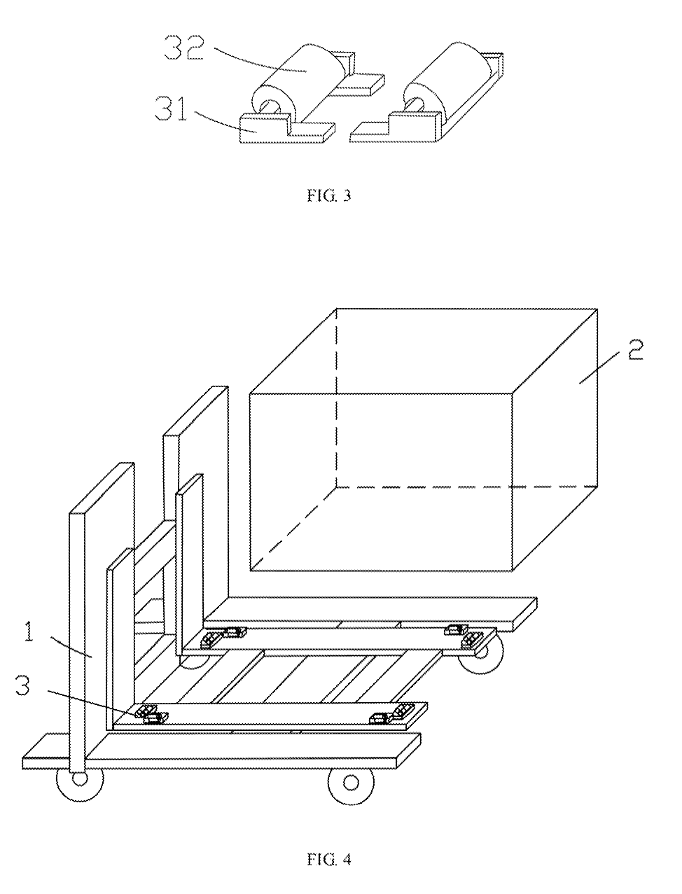

The present disclosure discloses a container transportation forklift. As a first example of the container transportation forklift of the present disclosure, as shown in FIG. 2 and FIG. 3, the container transportation forklift comprises a main body 1. The main body 1 is configured with roller guidance alignment devices 3 configured to guide a container 2 to enter a limiting position of the container transportation forklift.

In the example, the roller guidance alignment devices 3 are separated into four groups corresponding to four clamping blocks 21 on the container 2. Each of the four groups comprises at least one roller installation frame 31 and two rollers 32. The roller installation frame 31 is arranged on the main body 1 of the container transportation forklift. The two rollers 32 are parallel to each other, and a spacing is set between the two rollers 32. The spacing holds the clamping blocks 21 on the container 2.

The main body 1 of the container transportation forklift of the present disclosure is configured with roller guidance alignment devices configured to guide the container to enter the limiting position of the container transportation forklift. The rollers 32 of the roller guidance alignment device 3 can rotate and have an automatic guidance function. The container transportation forklift is only roughly moved below the container 2 to ensure that the container 2 can be pressed at inner sides of the rollers 32, thus, the container transportation forklift does not need to be completely aligned with the container. In process of raising the container, the inner sides of the rollers 32 are under stress so that the rollers 32 rotate inwards. Thus, the container 2 automatically enters the limiting position of the container transportation forklift. Because the container transportation forklift does not need to he completely aligned with the container, alignment time is shorter and transportation efficiency is high.

The rollers 32 of the example further clamp the clamping blocks 21 of the container. In transportation process of the container transportation forklift, shake and vibration of the container 2 can be alleviated, which avoids damaging workpieces in the container 2.

In the example, axes of the rollers 32 are parallel to a width direction of the container transportation forklift, and The container transportation forklift does not need to be completely aligned with the container in a length direction of the container transportation forklift. If axes of the roller are parallel to the length direction of the container transportation forklift, The container transportation forklift does not need to be completely aligned with the container in the width direction of the container transportation forklift. For the above two conditions, the latching groove of the main body in the prior art still needs to be partially retained, so as to accurately limit position of the container. In order to realize the container transportation forklift to not need to be completely aligned with the container in the length direction and the width direction of the container transportation forklift, and increase the transportation efficiency, the roller guidance alignment device comprises at least one roller installation frame 31 and four rollers 32. The axes of two rollers 32 are parallel to the length direction of the container transportation forklift, and the axes of the other two rollers 32 are parallel to the width direction of the container transportation forklift. The four rollers 32 are arranged in a square to hold the clamping blocks on the container.

In the example, only one group or two groups of the roller guidance alignment devices can be arranged, which almost has same function.

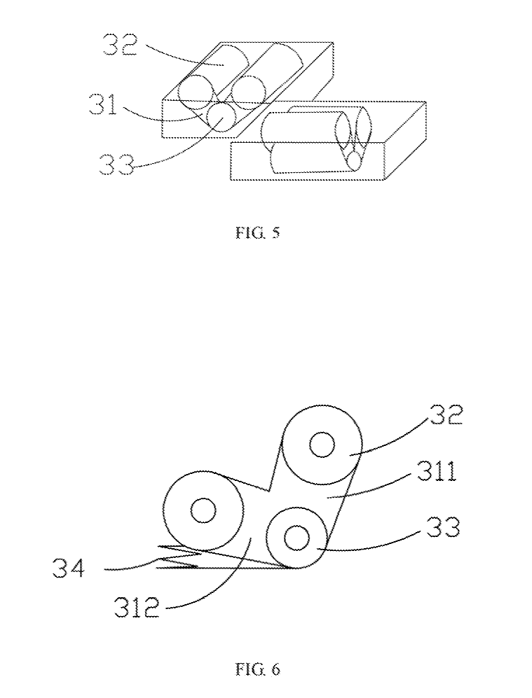

As a second example of the container transportation forklift of the present disclosure, as shown in FIG. 4 to FIG. 6, difference between the first example and the second example is that the roller guidance alignment device 3 comprises at least two oppositely positioned roller installation frames 31, two fixing, shafts 33, four rollers 32, and a resetting piece 34. The fixing shafts 33 are arranged on the main body 1 of the container transportation forklift. The roller installation frames 31 can rotate around the fixing shafts 33 and comprise a first arm 311 and a second arm 312. The rollers 32 are arranged on the first arm 311 of the roller installation frames and the second arm 312 of the roller installation frames 31. When the container 2 is not on the container transportation forklift, the resetting piece 34 enables the first arm 311 and the second arm 312 to incline upwards. when the container 2 is on the container transportation forklift, the rollers 32 on the first arm 311 and the second arm 312 contact with a sidewall and a bottom wall of the container 2.

In the example, the first arm 311 and the second arm 312 are mutually vertical, which can clamp one right-angle side of the container 2.

In the example, the resetting piece 34 is a resetting spring. One end of the resetting spring is arranged on the second arm 312 of the roller installation frames, and an opposite end of the resetting spring is arranged on the main body 1 of the container transportation forklift.

In the example, there are no clamping blocks on the container 2. The roller guidance alignment device 3 enables the container 2 to enter the limiting position of the container transportation forklift through the sidewall of the container 2. When the container 2 is not on the container transportation forklift, the resetting piece 34 enables the first arm 311 and the second arm 312 to incline upwards. Thus, the container transportation forklift is only roughly moved below the container 2 to ensure that the container 2 can be pressed at inner sides of the rollers 32 on the first arm 311. The container transportation forklift can be raised when the container transportation forklift does not need to be completely aligned with the container. In the process of raising the container 2, the rollers 32 on the second arm 312 of the roller installation frames 31 are under stress so that the roller installation frames 31 rotate inwards so that the rollers 32 on the first arm 311 of the roller installation frames 31 are driven to the sidewall of the container 2. Thus, the container 2 enters the limiting position. Because the container transportation forklift does not need to be completely aligned, with the container, alignment time is shorter and transportation efficiency is increased. As the rollers 32 are in slip friction with the sidewall and the bottom wall of the container 2, wearing of the container 2 is reduced. In the example, the rollers 32 further clamp the container 2. In the transportation process of the container transportation forklift, shake and vibration of the container 2 can be alleviated, which avoid damaging workpieces in the container 2.

In the example, axes of two or more of the rollers are parallel to the length direction of the container transportation forklift. Axes of the two or more of the rollers are parallel to the width direction of the container transportation forklift. Thus, the container transportation forklift does not need to be completely aligned with the container in the length direction and the width direction of the container transportation forklift, thus obtaining a better effect.

If axes of the rollers are only parallel to the length direction of the container transportation forklift, the container transportation forklift does not need to be completely aligned with the container in the width direction of the container transportation forklift. If axes of the rollers are parallel to the width direction of the container transportation forklift, the container transportation forklift does not need to be completely aligned with the container in the length direction of the container transportation forklift. Although the transportation efficiency may be reduced, the present disclosure is still better than the prior art.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

We claim:

1. A container transportation forklift, comprising:
a main body configured with a roller guidance alignment device configured to guide a container to enter a limiting position of the container transportation forklift;
wherein the roller guidance alignment deuce comprises at least two oppositely positioned roller installation frames, two fixing shafts, four rollers, and a resetting piece;
wherein the fixing shafts are arranged on the main body of the container transportation forklift; the roller installation frames rotate around the fixing shafts and comprise a first arm and a second arm;
wherein the rollers are arranged on the first arm of the roller installation frames and the second arm of the roller installation frames; when the container is not on the container transportation forklift, the resetting piece enables the first arm and the second arm to incline upwards; when the container is on the container transportation forklift, the rollers on the first arm and the second arm contact with a sidewall and a bottom wall of the container; and
wherein axes of two or more of the rollers are parallel to a length direction of the container transportation forklift; axes of the two or more of the rollers are parallel to a width direction of the container transportation forklift; the resetting piece is a resetting spring; one end of the resetting spring is arranged on the second arm of the roller installation frames, and an opposite end of the resetting spring is arranged on the main body of the container transportation forklift.

2. A container transportation forklift, comprising:
a main body configured with a roller guidance alignment device configured to guide a container to enter a limiting position of the container transportation forklift.

3. The container transportation forklift of claim 2, wherein the roller guidance alignment device comprises at least one roller installation frame and two rollers; the roller installation frame is arranged on the main body of the container transportation forklift; the two rollers are parallel, and a spacing is set between the two rollers.

4. The container transportation forklift of claim 3, wherein axes of the rollers are parallel to a width direction of the container transportation forklift.

5. container transportation forklift of claim 3, wherein axes of the rollers are parallel to a length direction of the container transportation forklift.

6. The container transportation forklift of claim 2, wherein the roller guidance alignment device comprises at least one roller installation frame and four rollers; the roller installation frame is arranged on the main body of the container transportation forklift; axes of two rollers are parallel to a length direction of the container transportation forklift, and axes of the other two rollers are parallel to a width direction of the container transportation forklift; the four rollers are arranged in a square.

7. The container transportation forklift of claim 2, wherein the roller guidance alignment deice comprises at least two oppositely positioned roller installation frames, two fixing shafts, four rollers, and a resetting piece; the fixing shafts are arranged on the main body of the container transportation forklift; the roller installation frames rotate around the fixing shafts and comprise a first arm and a second arm; the rollers are arranged on the first arm of the roller installation frames and the second arm of the roller installation frames; when the container is not on the container transportation forklift, the resetting piece enables the first arm and the second arm to incline upwards; when the container is on the container transportation forklift, the rollers on the first arm and the second arm contact with a sidewall and a bottom wall of the container.

8. The container transportation forklift of claim 7, wherein axes of the rollers are parallel to a length direction of the container transportation forklift.

9. The container transportation forklift of claim 7, wherein axes of the rollers are parallel to a width direction of the container transportation forklift.

10. The container transportation forklift of claim 7, wherein axes of two or more of the rollers are parallel to a length direction of the container transportation forklift; axes of the two or more of the rollers are parallel to a width direction of the container transportation forklift.

11. The container transportation forklift of claim 7, wherein the resetting piece is a resetting spring; one end of the resetting spring is arranged on the second arm of the roller installation frames, and an opposite end of the rescuing spring is arranged on the main body of the container transportation forklift.
